(19) United States
(12) Patent Application Publication
(10) Pub. No.: US 2012/0272272 A1
(43) Pub. Date: Oct. 25, 2012

(54) METHODS AND APPARATUS FOR AUTOMATICALLY OBTAINING AND SYNCHRONIZING CONTEXTUAL CONTENT AND APPLICATIONS

(76) Inventors: Sharad K. Garg, Portland, OR (US); Atul N. Hatalkar, Chandler, AZ (US); Alok K. Mathur, Cupertino, CA (US); John W. Carroll, Gilbert, AZ (US)

(21) Appl. No.: 13/518,193

(22) PCT Filed: Dec. 23, 2009
(86) PCT No.: PCT/US2009/069428

§ 371 Date: Jun. 21, 2012

(51) Int. Cl. H04N 21/431

(52) U.S. Cl. 725/40

(57) ABSTRACT

Methods and systems to present data to a viewer, where the data is specific to the viewer and his viewing experience and is stored locally. This data may be, for example, supplemental content or an application, such as a widget. In an embodiment, supplemental content, such as advertising, may be presented to the viewer where this content is aimed at the particular viewer in light of his or her viewer profile. In an alternative embodiment, a widget or other application may be presented to the viewer where the widget is specific to the current programming and thus tailored to the viewer's current viewing experience. In both situations, the data is stored locally and made available with minimal delay.

### BACKGROUND

The typical experience of television viewers may be mixed, in that it is a combination of desired content and irrelevant content. The viewer may be interested in a program, but is subject to commercials that may be of minimal interest. Currently there is some attempt by broadcasters to match advertising to the presumed demographics of the viewer. Football games are interspersed with beer commercials, on the assumption that football fans are likely to enjoy beer. But such advertising decisions are only assumptions and may not be accurate. Non-drinkers may enjoy football as well, while some beer drinkers may prefer non-sports programming. Other programming may defy attempts to categorize viewers. A crime drama may not have a well defined viewer demographic, in which case the advertising may have to take a scattershot approach. This may lead to advertising for a wide range of products in a single program. Here, the majority of advertisements are almost certain to be irrelevant to any given viewer. The viewer's time may be wasted, and the advertiser's resources are misspent.

Comparable problems may exist in the case of interactive viewing, where there may be applications available, such as widgets, for the viewer to use. A viewer is generally limited to a fixed set of applications. These applications may be useful to the viewer, but are just as likely to be irrelevant to the viewer. Moreover, there may be no connection between the applications that are made available and the content that is aired. The availability of irrelevant widgets therefore represents wasted memory as the widgets sit unneeded and unused.

While some attempts have been made to tailor the experience of the viewer to better suit individual needs and interests, these have proven to be awkward. Interposing targeted viewer-specific advertising can create an unacceptable delay, and any widgets that are made available to particular viewers are typically loaded manually. For both situations, delivery is cumbersome and may not be timely.

### BRIEF DESCRIPTION OF THE DRAWINGS/FIGURES

FIG. 1 is a block diagram illustrating a system in which the systems and methods described herein may operate, according to an embodiment.

FIG. 2 is a flowchart generally illustrating the processing of an embodiment.

FIG. 3 is a block diagram illustrating an embodiment where supplemental content is presented to a viewer.

FIG. 4 is a flowchart illustrating the process of providing data to a viewer, according to an embodiment.

FIG. 5 is a flowchart illustrating the delivery of supplemental content to a viewer, according to an embodiment.

FIG. 6 is block diagram illustrating a first software or firmware embodiment.

FIG. 7 is a block diagram generally illustrating the identification and delivery of an application, according to an embodiment.

FIG. 8 is a more detailed block diagram illustrating the identification and delivery of an application, according to an embodiment.

FIG. 9 is a flowchart illustrating the process of identifying and delivering an application to a viewer, according to an embodiment.

FIG. 10 is a more detailed flowchart illustrating a process for obtaining an application, according to an embodiment.

FIG. 11 is a flowchart illustrating the operation of an application, according to an embodiment.

FIG. 12 is a diagram illustrating a second software or firmware embodiment.

FIG. 13 illustrates an embodiment where the user may receive content and applications through a mobile device.

### DETAILED DESCRIPTION

Disclosed herein are methods and systems to present data to a viewer, where the data may be specific to the viewer and the viewing experience, and is stored locally. This data may be, for example, supplemental multi-media content or an application, such as a widget. In an embodiment, supplemental content, such as advertising, may be presented to the viewer where this content may be aimed at the particular viewer in light of his or her viewer profile. In an alternative embodiment, an application, such as a widget, may be presented to the viewer where the application may be specific to the current programming and thus tailored to the viewer's current viewing experience. In both situations, the data may be stored locally and made available with minimal delay.

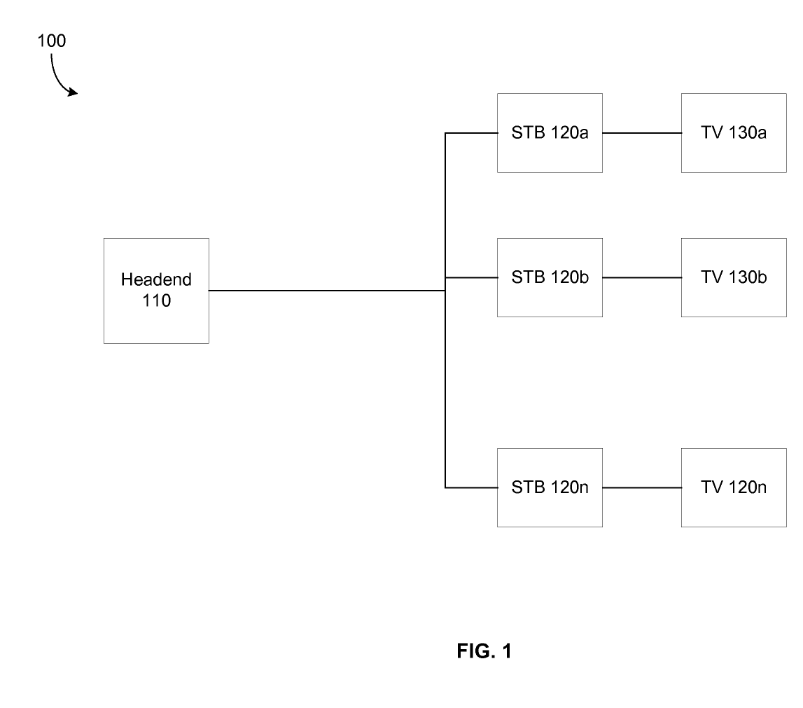

A possible context of the systems and methods described herein is illustrated in FIG. 1. Here, a headend 110, such as a cable headend, may be responsible for providing content to end users, or viewers. In alternative embodiments, the headend 110 may not be a cable headend; headend 110 may alternatively be a satellite headend or an internet protocol (IP) based source, for example. The headend 110 may be a media source of the content, and may perform network management functions. The users view this content through their respective displays, such as televisions 130a through 130n. At each viewer location, the content may be passed though a respective local device, such as a set-top box (STB). These are shown as STB 120a through 120n. In an alternative embodiment, the local device may not be a STB, but may be, for example, a television or other consumer electronics device. In an embodiment, each local device may be a microprocessor based device that includes a volatile and/or a non-volatile memory medium, such as a hard disk drive. A viewer may control his viewing experience in part through control of his local device, by choosing a program to view or choosing to record a program, for example.

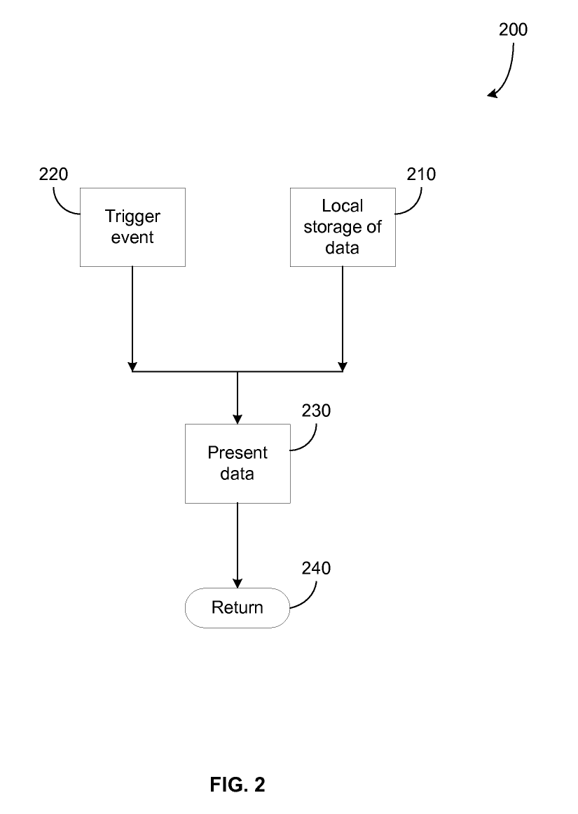

FIG. 2 illustrates the overall processing that is described herein. At 210, data may be stored locally at a viewer's location. In an embodiment, the data may be an application. Alternatively, the data may be supplemental content. The data may be stored at the local device associated with the viewer. At 220, a trigger event may take place, where the trigger may ultimately lead to the data being presented to the viewer at 230. In an embodiment, the trigger event 220 may take place before the local storage of the data at 210, such that the trigger 220 causes the local storage 210 of the data, which can subsequently be presented at 230. For example, metadata related to current programming may prompt the procurement and storage of an application that is relevant to the programming.

In an alternative embodiment, the local storage 210 may take place first, followed by the trigger event 210 which leads to the presentation 230. For example, a cue from a headend may be received at a local device, where the cue signifies that previously stored supplemental content is to be processed for presentation.

In any event, the data may be appropriate to the viewing context. The data may be related to the programming that is presently being presented to the viewer, for example, and/or may be a function of a profile of the viewer. The process may conclude at 240.

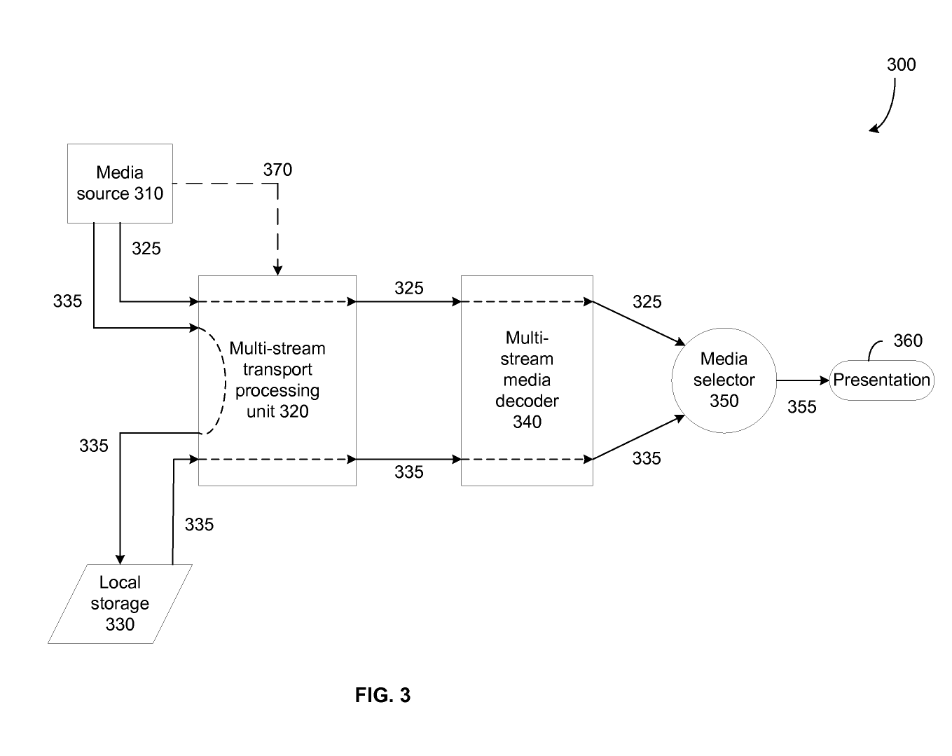

FIG. 3 illustrates an embodiment of the system described herein. The system 300 includes a media source 310. The media source 310 may be incorporated in a headend for example, and may be responsible for providing current programming 325 that ultimately appears in presentation 360. Media source 310 may also provide supplemental content 335. Supplemental content 335 represents content that may supplement or otherwise be presented in addition to current programming 325. Examples of supplemental content 335 may be advertisements or public service announcements, for example. Supplemental content 335 may take the form of one or more files formatted according to a Motion Picture Experts Group (MPEG) format, for example. In the illustrated embodiment, the supplemental content 335 may be stored at local storage 330 prior to being presented. In an embodiment, local storage 330 may be located in a viewer's local device, and may be implemented as a form of volatile or non-volatile memory, such as flash memory or a hard disk drive.

In an embodiment, supplemental content 335 may be tailored to a particular class of viewers, as determined by a previously derived profile of the viewer. For example, supplemental content 335 may include an advertisement for a business that is local to the viewer, such as a local car dealer or supermarket. If the profile shows the viewer to enjoy outdoor recreation, the advertisement may be for a hunting lodge or ski resort. Such a profile may be compiled by a service provider at the time of the initial service subscription, for example, or through any known means of marketing research. Alternative, the profile may be created or modified based on the content chosen by the viewer.

The current programming 325 may pass through a multi-stream transport processing unit 320, which may be responsible for interfacing the local device with the media source 310. The current programming 325 may then pass to a multi-stream media decoder 340 for purposes of decoding, decompression, and other related processing.

In the illustrated embodiment, the multi-stream transport processing unit 320 and the multi-stream media decoder 340 may collectively operate two separate but parallel media pipelines, as shown. This may allow the parallel processing and queuing of two separate media streams, where one or the other may be ultimately chosen by a media selector 350. In the illustrated embodiment, the current programming 325 may be the default selection and uses a first multi-media pipeline. Upon receipt of trigger, shown in this embodiment as a cue 370 from the media source 310, the supplemental content 335 may be read from local storage 330 and may be loaded into a second multi-media pipeline. The supplemental content 335 may then pass through the multi-stream transport processing unit 320 and may then be processed by the multi-stream media decoder 340.

At this point, both the current programming 325 and the supplemental content 335 may be available at a media selector 350. The chosen media stream 355 (which represents either supplemental content 335 or current programming 325, whichever is selected) appears in presentation 360. Under normal circumstances, current programming 325 may be chosen by media selector 350, until such time as the supplemental content 335 of the second media pipeline may be chosen by media selector 350 instead. When a predefined time slot in current programming 325 appears, the media selector 350 may switch from the first multi-media pipeline to the second. This may allow presentation of supplemental content 335 instead of current programming 325 during this slot. The beginning of the time slot may be marked by a flag in the current programming 325, for example. Alternatively, the media selector 350 may make this switch at a prearranged time mark that coincides with the time slot.

In an embodiment, the dual pipeline architecture may be implemented using a device such as the CE3100 available from Intel Corporation, for example. Referring to FIG. 3, a local device may incorporate the local storage 330, the multi-stream transport processing unit 320, the multi-stream media decoder 340, and the media selector 350 in an embodiment. Such an local device is not necessarily limited to these components, however.

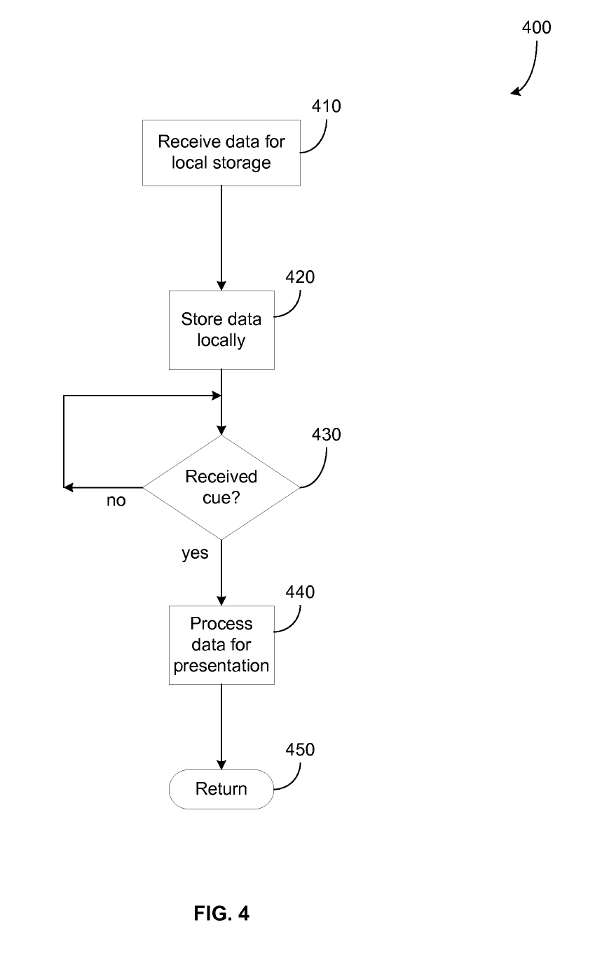

The processing associated with system 300 is illustrated in FIG. 4, according to an embodiment. At 410, data may be received from a media source for storage locally to the viewer. As discussed above, the data may include supplemental content, such as an advertisement in the form of one or more MPEG files, for example. At 420, the data may be stored. In an embodiment, local storage may reside in the viewer's local device. At 430, a determination may be made as to whether a cue has been received. As discussed above, the cue may be received from a headend that includes the media source, and may be received at the viewer's local device. Such a cue would lead to the presentation of the data, e.g., the supplemental content, to the viewer. If the cue has not been received, the process continues to wait; if the cue has been received, then the process may continue to 440. Here, the data may be processed for presentation to the viewer. The process may conclude at 450.

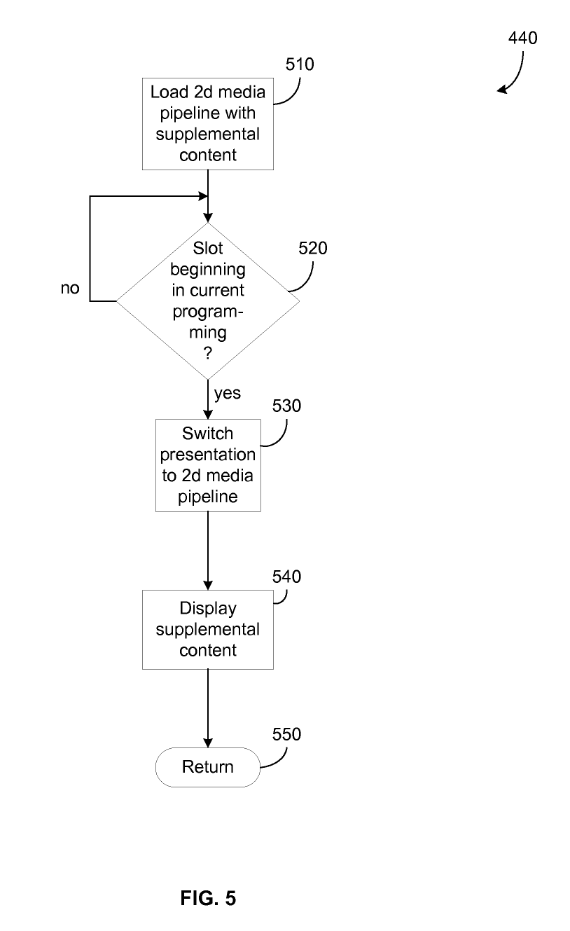

The process of processing data for presentation to the user (440 of FIG. 4) is shown in greater detail in FIG. 5, according to an embodiment. At this point, a cue has been received from the media source, as determined at 430 of process 400. At 510, as a result of the cue having been received, the supplemental content from the local storage unit may be loaded into a second media pipeline, where processing such as decoding and decompression can take place. Recall that a first media pipeline may be used for the current programming. At 520, a determination may be made as to whether a predefined slot has occurred in the current programming. If not, the process may continue to wait. If the slot has occurred, processing may continue at 530. Here, the presentation may be switched to the second media pipeline. This may allow the supplemental content to be presented to the viewer at 540, instead of the current programming. The process may conclude at 550.

The processing described above may be implemented in hardware, firmware, or software, or a combination thereof. In addition, any one or more features disclosed herein may be implemented in hardware, software, firmware, or combinations thereof, including discrete and integrated circuit logic, application specific integrated circuit (ASIC) logic, and microcontrollers, and may be implemented as part of a domain-specific integrated circuit package, or a combination of integrated circuit packages. The term software, as used herein, may refer to a computer program product including a computer readable medium having computer program logic stored therein to cause a computer system to perform one or more features and/or combinations of features disclosed herein.

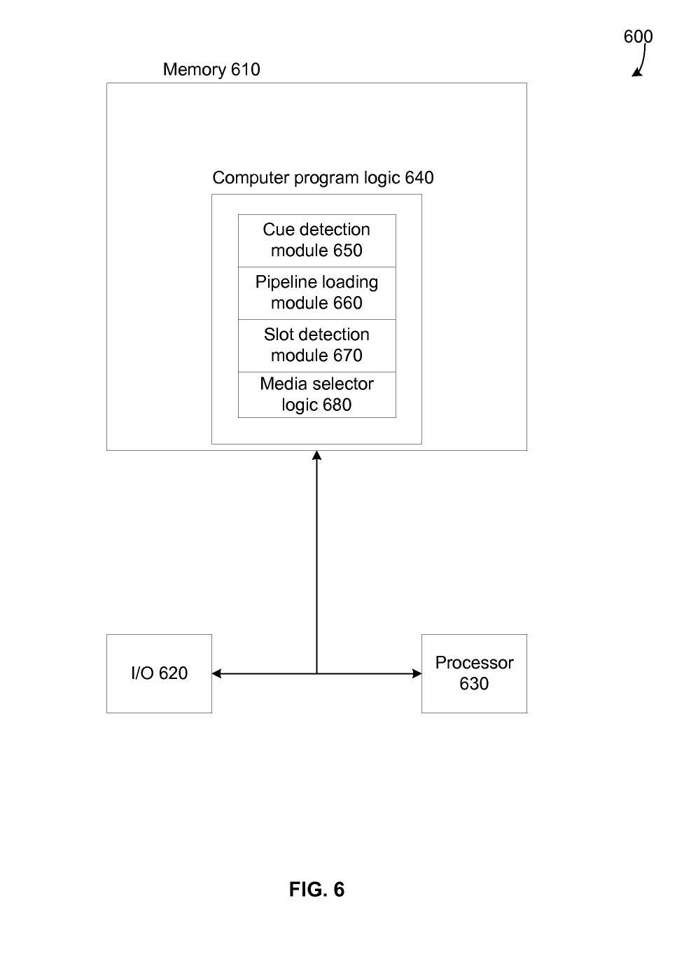

A software or firmware embodiment of the processing described above is illustrated in FIG. 6. System 600 may include a processor 630 and a body of memory 610 that may include one or more computer readable media that may store computer program logic 640. Memory 610 may be implemented as a hard disk and drive, a removable media such as a compact disk and drive, or a read-only memory (ROM) device, for example, or some combination thereof. Processor 630 and memory 610 may be in communication using any of several technologies known to one of ordinary skill in the art, such as a bus. Logic contained in memory 610 may be read and executed by processor 630. One or more I/O ports and/or I/O devices, shown collectively as I/O 620, may also be connected to processor 630 and memory 610. I/O 620 may include a monitor on which current programming and supplemental content may be presented to the viewer, for example. Moreover, some or all components of system 600 may be incorporated in a local device, which may include memory 610, I/O 620 and processor 630, but is not necessarily limited to these components.

Computer program logic 640 may include several logic modules as shown in FIG. 6. A cue detection module 650 may be responsible for detecting the arrival of a cue from the media source. The cue may signify that supplemental content may be loaded into the second media pipeline. This loading may be handled by pipeline loading module 660. Slot detection module 670 may be responsible for the detection of a slot in the current programming that is otherwise being processed by the first media pipeline. Once the slot is detected, the presentation may be switched from the first media pipeline to the second media pipeline by the media selection logic 680. This switches the presentation from the current programming to the supplemental content of the second media pipeline. While the illustrated embodiment shows computer program logic modules 650-680, system 600 is not necessarily limited to these modules.

In an alternative embodiment, an application such as a widget may be provided for the use of a viewer, where the application may be chosen on the basis of the viewing context. For example, an application may be provided where the utility of the application is related to the current programming being viewed.

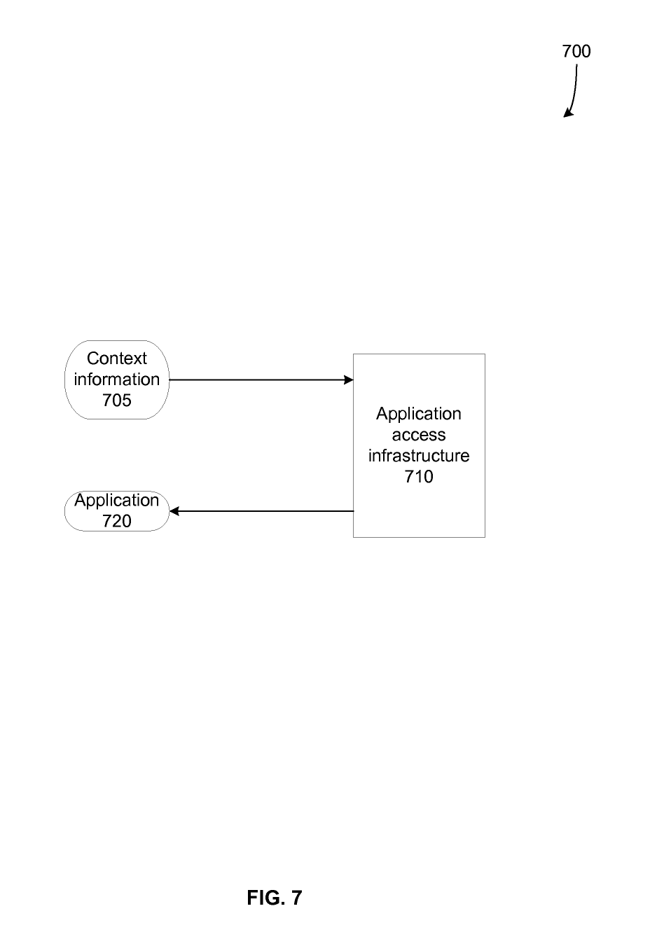

This is illustrated generally in the embodiment of FIG. 7. Context information 705 may be provided to application access infrastructure 710. Context information 705 may be related to the current programming being presented to the viewer. In particular, context information 705 may include metadata associated with the current Programming. An application access infrastructure 710 may use the context information 705 to access an appropriate application 720, i.e., an application that may be useful to the viewer in light of the current programming. As an example, the current programming might be a reality program or game show where viewers are invited to vote for a particular contestant. Based on the metadata that accompanies this program, the system may retrieve an application that allows the viewer to cast a vote. The application access infrastructure 710 may be a combination of components that are local to the viewer, e.g., present in the viewer's local device, and components that are remote.

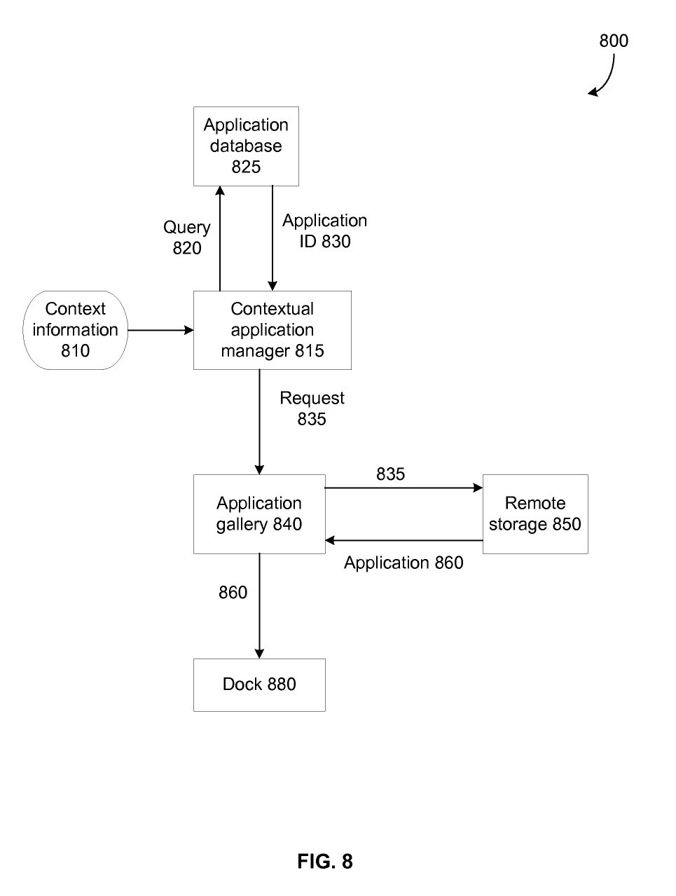

This is illustrated in the embodiment of FIG. 8. Here, context information 810 may be drawn from the metadata associated with the current programming being presented to the viewer and may be passed to a contextual application manager 815. Contextual application manager 815 may be responsible for identifying and procuring an application appropriate to the current programming. In an embodiment, the metadata and context information may reference a specific application. Alternatively, the context information may merely characterize the current programming in some manner. To do obtain an appropriate application, contextual application manager 815 may formulate a query 820 based on context information 810, and may send query 820 to an application database 825. The application database 825 may then respond to the query by returning an identifier (ID) 830 for an application that is appropriate for the current context, i.e., the current programming.

The contextual application manager 815 may then create a request 835 for the identified application. The request 835 may include the application identifier 830, and may be sent to an application gallery 840. The application gallery 840 may be viewed as an access point for parties seeking particular applications, analogous in some respects to an on-line applications store or on-line catalog. The application gallery 840 may not be an actual repository for applications. In an embodiment, the request 835 may be sent to more than one application gallery.

In the illustrated embodiment, the application gallery 840 may forward the request 835 (or some reformatted version thereof) to a remote storage facility 850. Such a facility may be a server, for example. The remote storage facility 850 may then return the requested application 860. In an embodiment, the remote storage facility 850 may be remote from the viewer's immediate location and may be accessible via a computer network, such as local or wide area network or the Internet, or some combination thereof.

The application 860 may then be downloaded to an application dock 880. In an embodiment, the loading of application 860 to the dock 880 may serve to initiate or activate the application 860, so that its execution begins. The dock 880 may be a data structure with an accompanying user interface, through which a user may begin interaction with, i.e., drive, applications residing thereon. In an embodiment, the downloading may take place under the control of the contextual application manager 815.

Upon completion of the current programming, applications related to this programming may no longer be useful. At this point, the context information may change, given that the current programming has changed. Applications related to the current programming may then be deleted from the dock 880. In an embodiment, this deletion may take place under the control of the contextual application manager 815.

In an embodiment, the contextual application manager 815 and dock 880 are located at the viewer's locale, at a local device for example. The application gallery 840 and remote storage facility 850 may be located remotely. The application database 825 may be located locally or remotely.

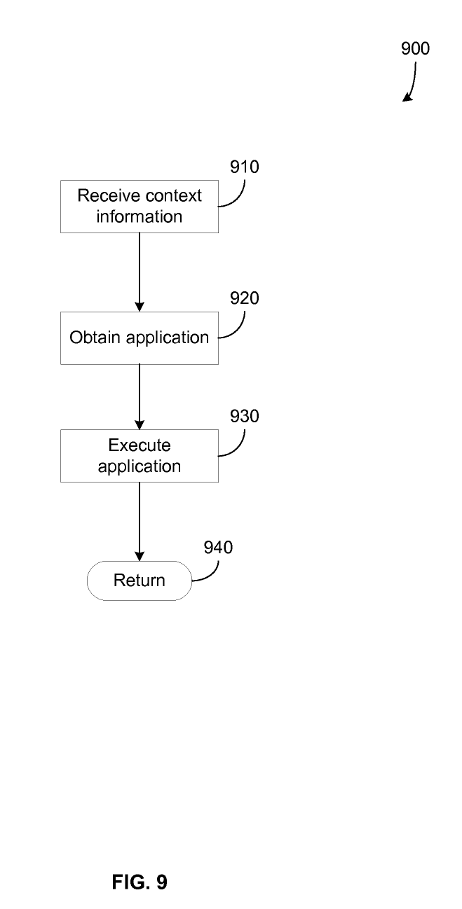

The processing of system 800 is illustrated generally in FIG. 9, according to an embodiment. At 910, context information may be received. As discussed above, this context information may include metadata related to current programming. At 920, an application may be obtained. The application may be obtained on the basis of the context information, such that the application may be appropriate in the context of the current programming. At 930, the application may execute. This may include activation and operation of the application with viewer input.

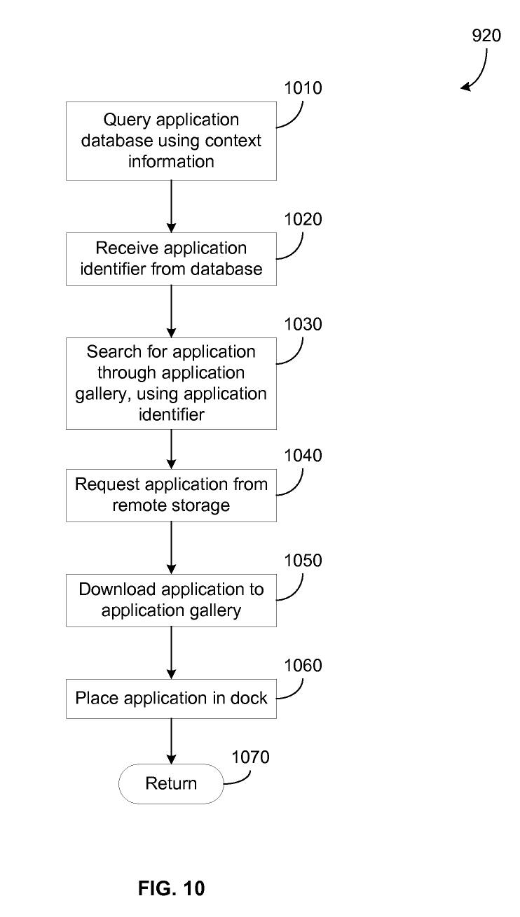

Obtaining the application (920 above) is illustrated in greater detail in FIG. 10, according to an embodiment. At 1010, an application database may be queried, where the query is formulated on the basis of the context information. The query may seek the identity of an application that is appropriate to the context of the current programming. At 1020, an application identifier may be returned from the database, where the identifier may correspond to an application that satisfies the query.

At 1030, the application identifier may be used to search for the actual application by using an application gallery. In an embodiment, more than one application gallery may be used to find the application. At 1040, the application may be requested from a remote storage facility once the application is found through the application gallery. At 1050, the application may be downloaded from the remote storage to the application gallery. In an embodiment, this download may be performed under the control of the contextual application manager. At 1060, the application may be moved to a dock, where the application may be made available to the viewer. From the dock, the viewer may see the application through a user interface and may be free to interact with it. The process may conclude at 1070.

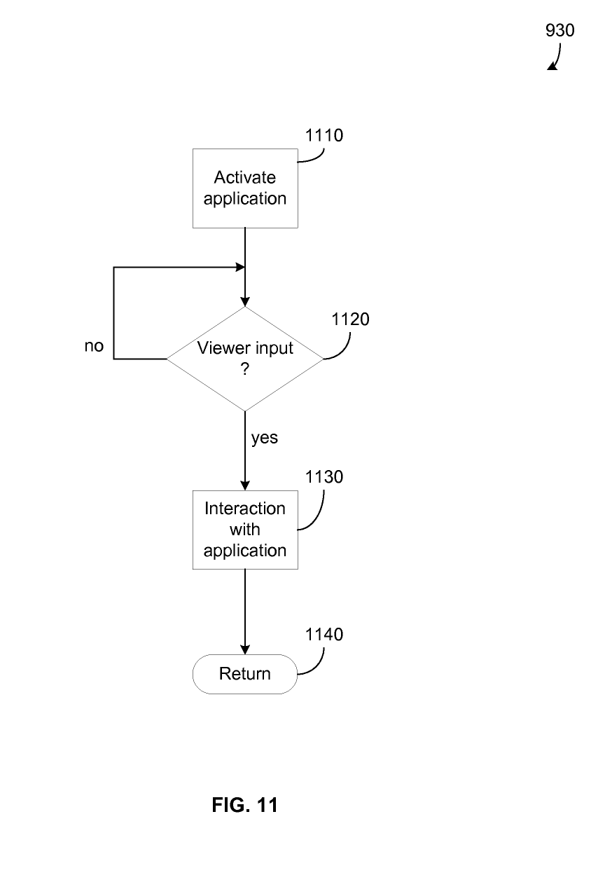

Execution of the application (930 of FIG. 9) is illustrated in FIG. 11, according to an embodiment. At 1110, the application may be activated. In an embodiment, the activation may be performed by the contextual application manager. At 1120, a determination may be made as to whether any viewer input has been received with respect to the application. If not, the process may wait until input is received. If input is received, then in 1130, interaction between the viewer and the application may proceed. The process may conclude at 1140.

The processing described above with respect to FIGS. 9-11 may be implemented in hardware, firmware, or software, or a combination thereof. In addition, any one or more features disclosed herein may be implemented in hardware, software, firmware, or combinations thereof, including discrete and integrated circuit logic, application specific integrated circuit (ASIC) logic, and microcontrollers, and may be implemented as part of a domain-specific integrated circuit package, or a combination of integrated circuit packages. As noted above, the term software, as used herein, may refer to a computer program product including a computer readable medium having computer program logic stored therein to cause a computer system to perform one or more features and/or combinations of features disclosed herein.

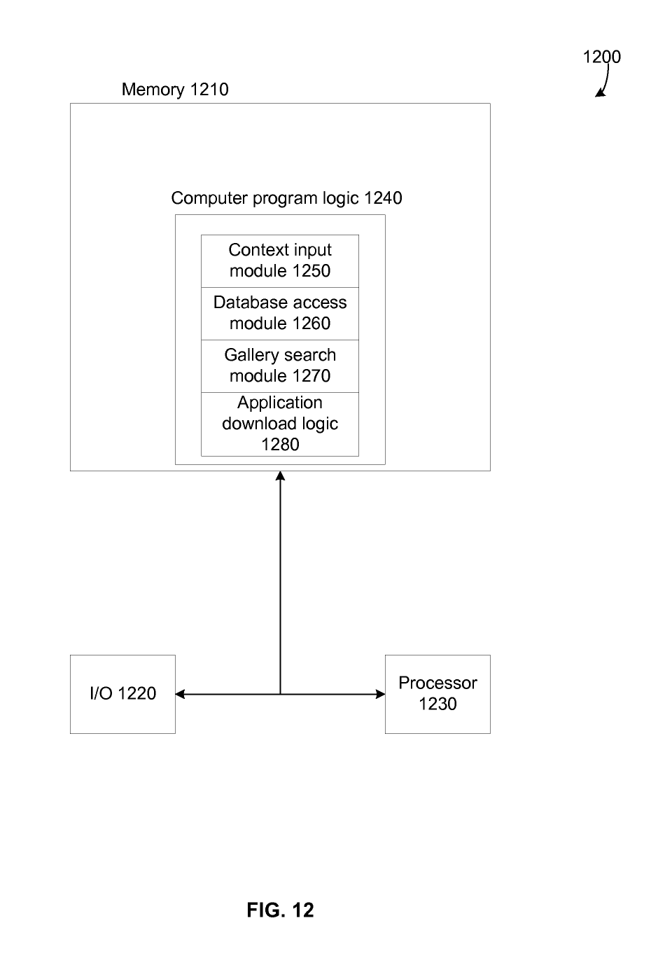

A software or firmware embodiment of the processing described above with respect to FIGS. 9-11 is illustrated in FIG. 12. System 1200 may include a processor 1230 and a body of memory 1210 that may include one or more computer readable media that store computer program logic 1240. Memory 1210 may be implemented as a hard disk and drive, a removable media such as a compact disk and drive, or a read-only memory (ROM) device, for example, or a combination thereof. Processor 1230 and memory 1210 may be in communication using any of several technologies known to one of ordinary skill in the art, such as a bus. Logic contained in memory 1210 may be read and executed by processor 1230. One or more I/O ports and/or I/O devices, shown collectively as I/O 1220, may also be connected to processor 1230 and memory 1210. I/O 1220 may include a monitor on which current programming and applications may be presented to the viewer, and through which the viewer may interact with the applications, for example. Moreover, system 1200 may be incorporated in a local device and may include memory 1210, I/O 1220, and processor 1230, but is not necessarily limited to these components.

Computer program logic 1240 may include several logic modules as shown in FIG. 12. The context input module 1250 may be responsible for receiving the context information. The database access module 1260 may be responsible for accessing the application database. This may include logic for formulating a query based on the context information, sending the query to the application database, and receiving an application identifier in response to the query. The gallery search module 1270 may be responsible for searching one or more application galleries for the application associated with the identifier returned from the application database. The application download module 1280 may be responsible for downloading the application from a remote source to the application gallery, and placing the application in the dock for viewer access.

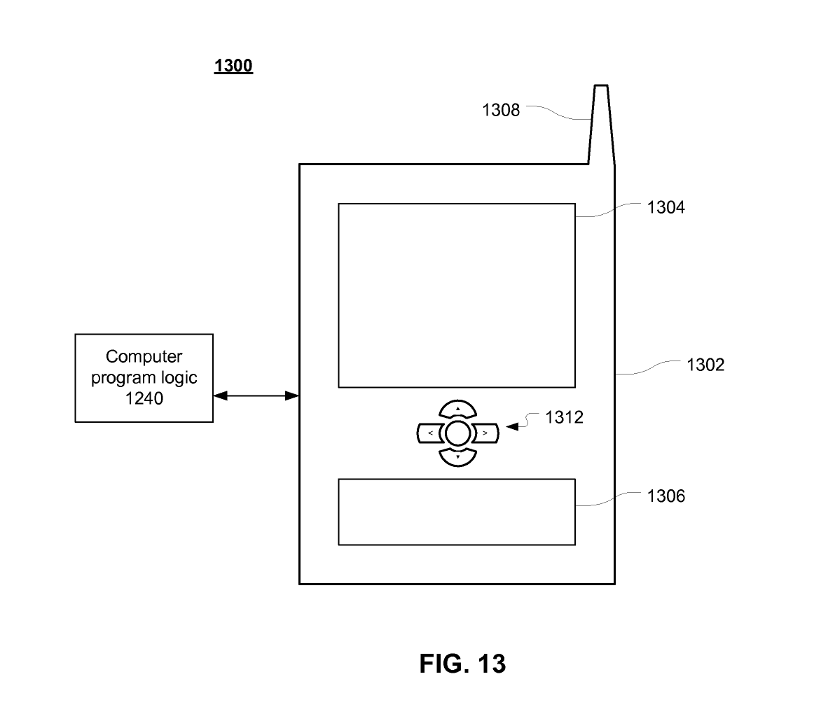

FIG. 13 illustrates one embodiment of a device 1300 in which some or all of the functionality described herein may be implemented. In one embodiment, for example, device 1300 may comprise a communication system. In various embodiments, device 1300 may comprise a processing system, computing system, mobile computing system, mobile computing device, mobile wireless device, computer, computer platform, computer system, computer sub-system, server, workstation, terminal, personal computer (PC), laptop computer, ultra-laptop computer, portable computer, handheld computer, personal digital assistant (PDA), cellular telephone, combination cellular telephone/PDA, smart phone, pager, one-way pager, two-way pager, messaging device, Blackberry®, MID, MP3 player, and so forth. The embodiments are not limited in this context.

A mobile computing device may refer to any device having a processing system and a mobile power source or supply, such as one or more batteries, for example. In one embodiment, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 13, device 1300 may comprise a housing 1302, a display 1304, one or more input/output (I/O) devices 1306, and an antenna 1308. Device 1300 also may comprise navigation controls 1312.

Display 1304 may comprise any suitable display unit for displaying information appropriate for a mobile computing device. I/O devices 1306 may comprise a suitable keyboard, a microphone, and/or a speaker, for example. I/O devices 1306 may comprise any suitable I/O device for entering information into a mobile computing device. Examples for I/O devices 1306 may include an alphanumeric keyboard, a numeric keypad, a touch pad, input keys, buttons, switches, rocker switches, voice recognition device and software, and so forth. Information also may be entered into device 1300 by way of a microphone. Such information may be digitized by voice recognition logic. The embodiments are not limited in this context.

In embodiments, device 1300 is adapted to include the functionality of the invention as described herein. In one embodiment, computer program logic 1240 (FIG. 12) is used to enable the functionality of the invention as described herein.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Thus, the breadth and scope of the claims should not be limited by any of the exemplary embodiments disclosed herein.

What is claimed is:

1. A method, comprising:
storing data locally in a local device wherein the data is specific to a context of current programming;
receiving at the local device a trigger that results in presentation of the data to a viewer; and
presenting the data to the viewer,
wherein the data comprises one of supplemental content or an application.

2. The method of claim 1, wherein the data comprises supplemental content, and the trigger comprises a cue received from a headend.

3. The method of claim 2, further comprising:
loading the current programming into a first media pipeline; and
when the cue is received at the local device, loading a second media pipeline with the supplemental content.

4. The method of claim 3, further comprising:
after the second media pipeline is loaded with the supplemental content, waiting for a slot to occur in a presentation to the viewer of the current programming; and
upon occurrence of the slot, switching the presentation from the first media pipeline to the second media pipeline.

5. The method of claim 2, wherein the headend comprises a media source for the current programming.

6. The method of claim 2, wherein the headend comprises a media source for the supplemental content.

7. The method of claim 1, wherein the data comprises an application, and the receiving of the trigger comprises receiving of context information regarding the current programming.

8. The method of claim 7, wherein the context information comprises metadata associated with the current programming.

9. The method of claim 7, wherein said storing data locally comprises:
querying an application database on the basis of the context information;
receiving an identifier of the application in response to said querying;
searching for the application in an application gallery, on the basis of the identifier;
requesting the application from a remote source;
downloading the application; and
storing the application in a dock.

10. The method of claim 9, further comprising:
removing the application from the dock when the context information changes.

11. The method of claim 7, further comprising:
initiating the application to begin its execution.

12. The method of claim 7, further comprising:
accepting viewer inputs through which the viewer interacts with the application.

13. The method of claim 7, wherein said receiving of the context information precedes said storing of data locally.

14. A system, comprising:
a local storage unit configured to store supplemental content; and
a media selector in communication with said local storage unit and with a media source,
wherein said media selector is configured to receive current programming from said media source and to receive supplemental content from said local storage unit, and is further configured to select said supplemental content upon occurrence of a slot in said current programming.

15. The system of claim 14, wherein said media source is included in a headend.

16. The system of claim 14, wherein said local storage unit comprises one or more of a volatile or non-volatile memory.

17. The system of claim 14, wherein the system is incorporated in a local device.

18. The system of claim 14, further comprising:
a multi-stream transport processing unit in communication with said media source and said local storage unit,
wherein said multi-stream transport processing unit is configured to receive said current programming from said media source and forward said current programming to said media selector, and is further configured to receive said supplemental content from said local storage unit and send said supplemental content to said media selector.

19. The system of claim 18, wherein said multi-stream transport processing unit is further configured to receive said supplemental content from said media source, to write said supplemental content to said local storage unit, and to read said supplemental content from said local storage unit prior to sending said supplemental content to said media selector.

20. The system of claim 18, further comprising:
a multi-stream media decoder configured to receive said supplemental content and said current programming from said multi-stream transport processing unit, to decode said supplemental content and said current programming, and to forward said supplemental content and said current programming to said media selector.

21. The system of claim 20, wherein said multi-stream media decoder comprises:
a first media pipeline configured to decode said current programming in advance of forwarding said current programming to said media selector; and
a second media pipeline configured to decode said supplemental content in advance of forwarding said supplemental content to said media selector.

22. The system of claim 21, wherein said second media pipeline is configured to receive said supplemental content when a cue is received from said media source.

23. A system comprising:
an application database; and
a contextual application manager configured to receive context information and, based on said context information, receive an application identifier from said application database, and further configured to request the application identified by said identifier for presentation to a viewer.

24. The system of claim 23, wherein said contextual application manager is further configured to
formulate a query based on said context information,
present said query to said application database, and
receive the application identifier from said application database in response to said query.

25. The system of claim 23, further comprising:
a application gallery, configured to provide access to the application, wherein said contextual application manager is configured to request the application from said application gallery.

26. The system of claim 25,
wherein said application gallery is further configured to obtain said application from a remote storage facility, and
wherein said contextual application manager is configured to download the application from said remote storage facility.

27. The system of claim 26, further comprising an application dock, viewable by said viewer, wherein said contextual application manager is further configured to transfer said application to said application dock.

28. The system of claim 27, wherein said contextual application manager is further configured to remove said application from said dock when said context information changes.

29. The system of claim 27, wherein said contextual application manager and said dock are incorporated in a local device.

30. A computer program product including a computer readable medium having computer program logic stored therein, the computer program logic including:
logic to cause a processor to store supplemental content locally at a local device where the supplemental content is specific to current programming;
logic to cause the processor to receive a trigger that results in presentation of the supplemental content to a viewer; and
logic to cause the processor to present the supplemental content to the viewer.

31. The computer program product of claim 30, wherein the trigger comprises a cue received from a headend.

32. The computer program product of claim 31, wherein the computer program logic further comprises:
logic to cause the processor to load a first media pipeline with the current programming; and
logic to cause the processor to load a second media pipeline with the supplemental content when the cue is received.

33. The computer program product of claim 32, wherein the computer program logic further comprises:
logic to cause the processor to wait, after the loading of the second media pipeline with the supplemental content, for a slot to occur in a presentation of the current programming to the viewer; and
logic to cause the processor to switch the presentation from the first media pipeline to the second media pipeline upon occurrence of the slot.

34. The computer program product of claim 31, wherein the headend comprises a media source for the current programming.

35. The computer program product of claim 31, wherein the headend comprises a media source for the supplemental content.

36. A computer program product including a computer readable medium having computer program logic stored therein, the computer program logic including:
logic to cause a processor to store an application locally in a local device, where the application is specific to programming;
logic to cause the processor to receive a trigger that results in presentation of the application to a viewer; and
logic to cause the processor to present the application to the viewer.

37. The computer program product of claim 36, wherein the receiving of the trigger comprises receiving context information regarding the programming.

38. The computer program product of claim 37, wherein the context information comprises metadata associated with the programming.

39. The computer program product of claim 37, wherein said logic to cause the processor to store the application locally comprises:
logic to cause the processor to query an application database on the basis of the context information;
logic to cause the processor to receive an identifier of an application in response to the querying;
logic to cause the processor to search for the application in an application gallery, on the basis of the identifier;
logic to cause the processor to request the application from a remote source;
logic to cause the processor to download the application; and
logic to cause the processor to store the application in a dock.

40. The computer program product of claim 39, wherein the computer program logic further comprises:
logic to cause the processor to initiate the application to begin its execution.

41. The computer program product of claim 40, wherein the computer program logic further comprises:
logic to cause the processor to accept viewer inputs that allow the viewer to interact with the application.

42. The computer program product of claim 37, wherein the receiving of the context information precedes the storing of the application locally.

43. The computer program product of claim 39, wherein the computer program logic further comprises:
logic to cause the processor to remove the application from the dock when the context information changes.
